(19) United States
(12) Patent Application Publication
(10) Pub. No.: US 2008/0176008 A1
(43) Pub. Date: Jul. 24, 2008

(54) Apparatus and method for forming magnetic film

(76) Inventors: Xinming Wang, Tokyo (JP); Akira Owatari, Tokyo (JP); Takashi Koba, Tokyo (JP); Tsutomu Nakada, Tokyo (JP); Akira Fukuda, Kanagawa-ken (JP)

Correspondence Address: WENDEROTH, LIND & PONACK, L.L.P., 2033 K STREET N. W., SUITE 800, WASHINGTON, DC, 20006-1021, US

(21) Appl. No.: 12/010,181

(22) Filed: Jan. 22, 2008

(30) Foreign Application Priority Data
Jan. 23, 2007 (JP) 2007-012341

(51) Int. Cl. H01F 10/08

(52) U.S. Cl. 427/599; 118/623

(57) ABSTRACT

A magnetic film forming apparatus can form a magnetic film, especially a magnetic alloy film, selectively on a metal surface exposed on a surface of a substrate, such as a semiconductor wafer. The magnetic film forming apparatus comprises an electroless plating apparatus having a magnetic field generation apparatus for generating a magnetic field around and parallel to a substrate disposed such that the surface of the substrate is in contact with a plating solution in a plating tank.

### BACKGROUND OF THE INVENTION

1. Field of the Invention

The present invention relates to an apparatus and a method for forming a magnetic film, and more particularly to an apparatus and a method for forming a magnetic film, which are useful for forming a magnetic film, especially a magnetic alloy film, selectively on a metal surface exposed on a surface of a substrate, such as a semiconductor wafer.

2. Description of the Related Art

Sputtering using a PVD apparatus, electroplating, etc. are generally known as a technique for forming a magnetic film in a device, such as an MRAM or a magnetic head. For example, for the formation of a magnetic film in a magnetic head using electroplating, there have been proposed a method in which a pair of magnets is disposed outside and on opposite sides of a plating tank, and electroplating of a surface of a sample is carried out while stopping a rotating electrode, housing the sample therein, in such a manner that the sample is oriented in the direction of the magnetic line formed between the magnets and in a direction perpendicular to the magnetic line direction (Japanese Patent Laid-Open Publication No. 5-17898), a method in which magnets are disposed on opposite sides of a plating bath, and the magnetic field distribution is adjusted, for example, by adjusting the thicknesses of the magnets or by providing an adjustment hole in the magnets (Japanese Patent Laid-Open Publication No. 11-25424), etc.

### SUMMARY OF THE INVENTION

In the case where a magnetic film is formed on a metal surface by sputtering using a PVD apparatus, there is an advantage in that the magnetic field applied during the film formation can be easily controlled and a film having a uniform thickness can be easily obtained. However, the sputtering method has disadvantages that it is generally difficult to form a magnetic film of an alloy while controlling the composition of the magnetic film, that the speed of film formation is generally slow, which is unsuited for the formation of a thick magnetic film, and that it is difficult to form a magnetic film selectively on a metal surface exposed on a surface of a substrate, such as a semiconductor wafer.

In the case where a magnetic film is formed on a metal surface by electroplating, there are advantages in that the plating rate is generally high, which is suited for the formation of a thick magnetic film, and that in many cases, it is not necessary to use a high-temperature plating solution, making it possible to easily secure the stability of a plating solution. However, in the case of forming a magnetic film of an alloy, many restrictions are imposed on the types of alloys that can form a film, that is, the types of usable alloys are limited. Further, it is not easy to obtain a plated film having a uniform thickness. In addition, like the sputtering method using a PVD apparatus, it is difficult to form a magnetic film selectively on a metal surface exposed on a surface of a substrate, such as a semiconductor wafer.

The present invention has been made in view of the above situation in the related art. It is therefore an object of the present invention to provide an apparatus and a method for forming a magnetic film, which can form a magnetic film, especially a magnetic alloy film, selectively on a metal surface exposed on a surface of a substrate, such as a semiconductor wafer.

In order to achieve the above object, the present invention provides an apparatus for forming a magnetic film selectively on a metal surface exposed on a surface of a substrate, the apparatus comprising an electroless plating apparatus having a magnetic field generation apparatus for generating a magnetic field around and parallel to a substrate disposed such that the surface of the substrate is in contact with a plating solution in a plating tank.

By thus using, as an apparatus for forming a magnetic film, an electroless plating apparatus having a magnetic field generation apparatus for generating a magnetic field around and parallel to a substrate, it becomes possible to form a magnetic film, especially a magnetic alloy film, having excellent coercive force characteristics with a uniform direction in a plane parallel to a substrate, selectively on a metal surface exposed on the surface of the substrate. Further, the composition and the magnetic properties of a plated film, e.g., composed of a magnetic alloy, can be easily controlled by adjusting the composition of a plating solution and the plating conditions. Furthermore, unlike an electroplating apparatus, there is no need to pass an electric current in a plating solution from an external power source. This facilitates the installation of the magnetic field generation apparatus and, in addition, can provide a plated film having a uniform thickness.

The present invention provides another apparatus for forming a magnetic film selectively on a metal surface exposed on a surface of a substrate, the apparatus comprising an electroless plating apparatus including: a plating tank for holding a plating solution therein; a substrate holder for holding a substrate and bringing a surface of the substrate into contact with the plating solution in the plating tank; and a magnetic field generation apparatus, disposed outside the plating tank, for generating a magnetic field around and parallel to the substrate disposed such that the surface of the substrate is in contact with the plating solution in the plating tank.

The plating tank preferably holds the plating solution while allowing the plating solution to overflow the peripheral wall of the plating tank and circulate. Further, the plating tank preferably has a stirring device for stirring the plating solution held in the plating tank. This makes it possible to circulate and reuse the plating solution and to create a more uniform flow of the plating solution in the plating tank, making a thickness of a plated film (magnetic film) more uniform. Measurements or replenishment of the plating solution can be facilitated by allowing the plating solution to circulate between the plating tank and, e.g., a plating solution storage tank.

The substrate holder may hold the substrate in a horizontal position with the surface facing either upwardly or downwardly, or hold the substrate in a vertical position.

Preferably, the substrate holder is rotatable, and the magnetic field generation apparatus is adapted to rotate in synchronization with the substrate, held and being rotated by the substrate holder, in the same direction as the rotational direction of the substrate.

A thickness of a plated film can be made more uniform by carrying out plating while rotating the substrate at a low speed. Further, the direction of the magnetic field distributed over the substrate surface can be kept constant by rotating the magnetic field generation apparatus in synchronization with the substrate in the same direction as the rotational direction of the substrate.

The magnetic field generation apparatus may generate a magnetic field either by using a permanent magnet or by using an electric coil.

Preferably, the magnetic film forming apparatus further comprises a magnetic field shielding wall surrounding the magnetic field generation apparatus for shielding a magnetic field.

This can prevent a magnetic field (magnetism), generated by the magnetic field generation apparatus, from causing as a noise a malfunction of an electrical component.

The present invention also provides a method for forming a magnetic film, comprising applying a magnetic field around and parallel to a substrate while keeping a surface of the substrate in contact with a plating solution to carry out electroless plating of the surface of the substrate, thereby forming a magnetic film selectively on a metal surface exposed on the surface of the substrate.

The strength of the magnetic field may be changed continuously or in a stepwise manner.

Preferably, the magnetic field is uniformly distributed over the surface of the substrate at a magnetic flux density of 50 to 2000 gauss (0.005 to 0.2 tesla).

The present invention also provides a substrate processing apparatus comprising: the above-described magnetic film forming apparatus; an aligner for alignment of the orientation of a substrate; and a main frame housing the magnetic film forming apparatus and the aligner therein.

The orientation of a substrate can be confirmed or adjusted with a notch portion, an orientation flat, or the like of the substrate as a reference, using the aligner in the main frame.

Preferably, at least four magnetic film forming apparatuses are provided in the main frame.

There is a case in which one magnetic film forming apparatus needs a processing time of ten and several minutes to several tens of minutes for a substrate for which the formation of a magnetic film having a thickness of several hundred to several thousand nm is necessary. In such a case, the provision of at least four magnetic film forming apparatuses in the main frame can prevent the lowering of the throughput.

According to the present invention, a magnetic film, especially a magnetic alloy film, having excellent coercive force characteristics with a uniform direction in a plane parallel to a substrate, can be formed by electroless plating selectively on a metal surface exposed on the surface of the substrate. Further, the composition and the magnetic properties of a plated film, e.g., composed of a magnetic alloy, can be easily controlled by adjusting the composition of a plating solution and the plating conditions. Furthermore, a magnetic field generation apparatus can be installed with ease. In addition, a magnetic film (plated film) having a uniform thickness can be obtained.

### BRIEF DESCRIPTION OF THE DRAWINGS

FIG. 1 is a layout plan view of a substrate processing apparatus according to an embodiment of the present invention;

FIG. 2 is a schematic view of a magnetic film forming apparatus provided in the substrate processing apparatus shown in FIG. 1;

FIG. 3 is a front view of a magnetic field generation apparatus of the magnetic film forming apparatus shown in FIG. 2;

FIG. 4 is a cross-sectional view taken along line A-A of FIG. 3;

FIG. 5 is a schematic view showing another magnetic film forming apparatus;

FIG. 6 is a schematic view showing yet another magnetic film forming apparatus;

FIG. 7 is a layout plan view of a substrate processing apparatus according to another embodiment of the present invention;

FIG. 8 is a schematic view of a magnetic film forming apparatus provided in the substrate processing apparatus shown in FIG. 7;

FIG. 9 is a perspective view showing the main portion of the magnetic film forming apparatus shown in FIG. 8;

FIG. 10 is a diagram showing the distribution of a magnetic field, in the vicinity of a substrate, generated by the magnetic film forming apparatus shown in FIG. 8; and

FIG. 11 is a perspective view showing the main portion of yet another magnetic film forming apparatus.

### DETAILED DESCRIPTION OF THE PREFERRED EMBODIMENTS

Preferred embodiments of the present invention will now be described with reference to the drawings.

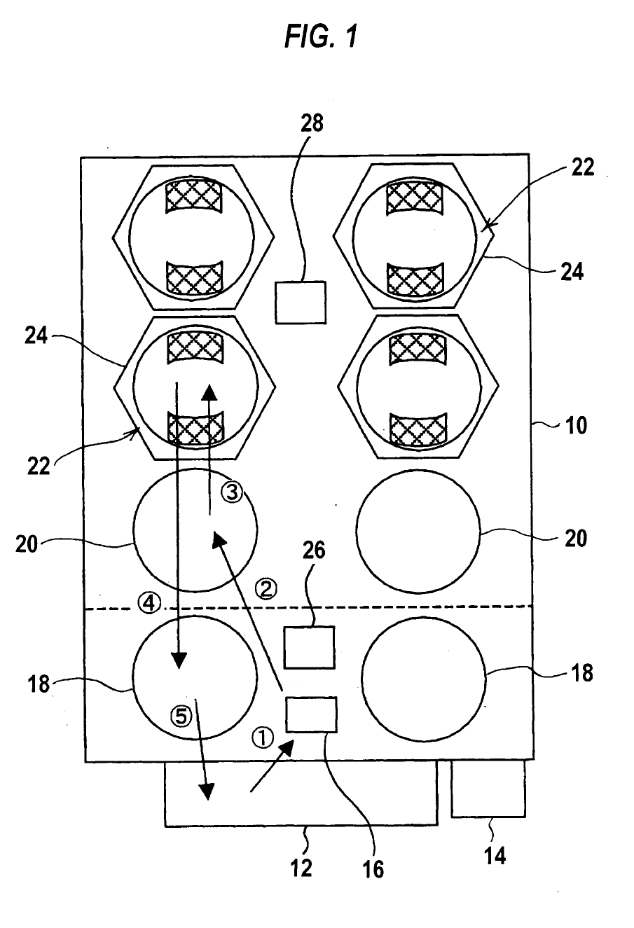

FIG. 1 shows a layout plan of a substrate processing apparatus according to an embodiment of the present invention. As shown in FIG. 1, the substrate processing apparatus includes a rectangular main frame 10, a loading/unloading section 12 equipped with a substrate cassette housing therein substrates, such as semiconductor wafers, and a control section 14.

In the interior of the main frame 10 are provided an aligner 16 for alignment of a notch portion, an orientation flat, or the like of a substrate, two cleaning/drying apparatuses 18 for cleaning (rinsing) the substrate with a cleaning liquid, such as pure water, and drying the substrate, two pretreatment apparatuses 20 for carrying out pretreatment of the substrate, and four magnetic film forming apparatuses 22 for forming a magnetic film, for example, composed of an alloy, selectively on a metal surface exposed on a surface of the substrate. Each magnetic film forming apparatus 22 is surrounded by a magnetic field shielding wall 24 that shields a magnetic field (magnetism), generated in the magnetic film forming apparatus 22, and prevents the magnetic field (magnetism) from causing as a noise a malfunction of an electrical component in the substrate processing apparatus. A fixed-type first substrate transport robot 26 is disposed at a position between the aligner 16, the cleaning/drying apparatuses 18 and the pretreatment apparatuses 20. Further, a traveling-type second substrate transport robot 28 is disposed between the pretreatment apparatuses 20 and the magnetic film forming apparatuses 22.

The cleaning/drying apparatus 18 used in this embodiment holds a substrate with its front surface facing upwardly and carries out cleaning processing of the front surface (upper surface) of the substrate, whereas the pretreatment apparatus 20 and the magnetic film forming apparatus 22 hold a substrate with its front surface facing downwardly and carry out processing of the front surface (lower surface) of the substrate.

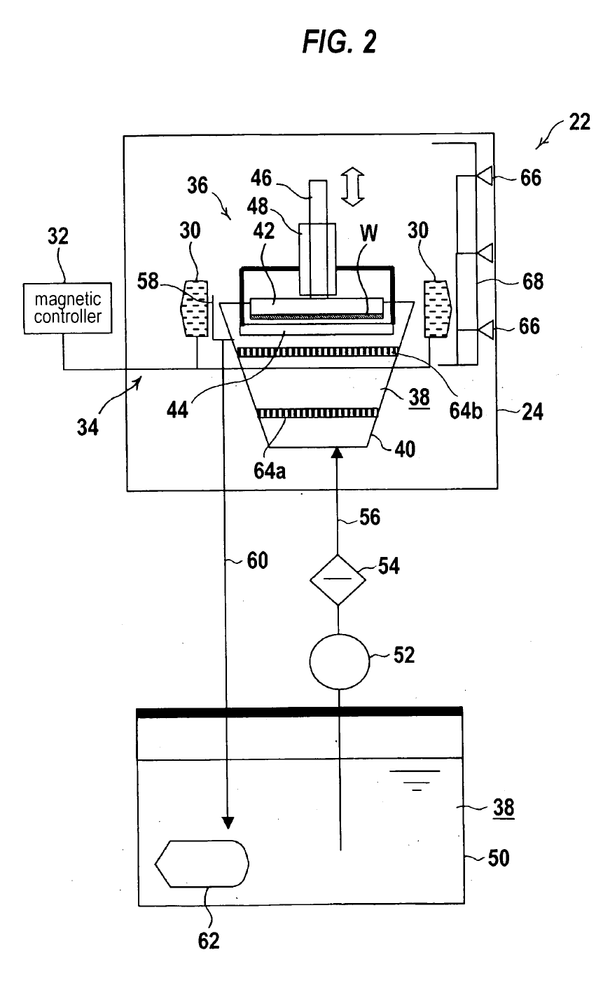

FIG. 2 shows the details of the magnetic film forming apparatus 22. As shown in FIG. 2, the magnetic film forming apparatus 22 in this embodiment is comprised of an electroless plating apparatus 36 which includes a magnetic field generation apparatus 34 having a pair of electromagnets 30, disposed opposite to each other, and a magnetic controller 32. The electromagnets 30 are provided with a cooling means (not shown). It is, of course, possible to use permanent magnets instead of the electromagnets 30. The above-described pretreatment apparatus 20 performs a pre-plating treatment.

The electroless plating apparatus 36 also includes an upwardly-open plating tank 40 for holding therein a plating solution 38, and a substrate holder 42, vertically-movably disposed above the plating tank 40, for detachably holding a substrate W in a horizontal position, for example, by attraction, with the front surface facing downwardly. Below the substrate holder 42 is disposed a stirring plate 44 for stirring the plating solution in the plating tank 40 during plating. The substrate holder 42 is coupled to the lower end of a lifting shaft 46, and the stirring plate 44 is coupled to the lower end of a rotating shaft 48 which, by a spline structure formed between it and the lifting shaft 46, moves up and down together with the lifting shaft 46 and rotates independently of the lifting shaft 46.

The plating tank 40 at the bottom is connected to a plating solution supply pipe 56 extending from a plating solution storage tank 50 and having a pump 52 and a filter 54 interposed. Around an upper portion of the plating tank 40 is provided an overflow tank 58 for receiving the plating solution that has overflowed the top of the plating tank 40. The overflow tank 58 and the plating solution storage tank 50 are connected by a plating solution return pipe 60. With this structure, by the actuation of the pump 52, the plating solution 38 in the plating solution storage tank 50 is supplied into the plating tank 40, and the plating solution 38 that has overflowed the top of the plating tank 40 is returned, via the overflow tank 58 and the plating solution return pipe 60, to the plating solution storage tank 50. In this manner, the plating solution 38 circulates between the plating tank 40 and the plating solution storage tank 50.

In the plating solution storage tank 50 is disposed a heating section 62 for heating the plating solution 38 in the plating solution storage tank 50 to, e.g., 50 to 95° C., preferably 65 to 85° C. In the plating tank 40 is disposed two current plates 64a, 64b for regulating the flow of the plating solution flowing upwardly in the plating tank 40.

The electromagnets 30 of the magnetic field generation apparatus 34 are located outside the plating tank 40 and in the vicinity of the liquid surface of the plating solution 38 held in the plating tank 40, and are disposed on opposite sides of the plating tank 40. Further, the electromagnets 30 of the magnetic field generation apparatus 34 are disposed such that when bringing the surface (lower surface) of the substrate W, held by the substrate holder 42, into contact with the plating solution 38 in the plating tank 40 and forming a plated film (magnetic film) by electroless plating selectively on a metal surface exposed on the substrate surface, the electromagnets 30 will apply a constant-direction, uniformly-distributed magnetic field to around the substrate W (at least to the surface (lower surface) of the substrate W) and parallel to the substrate W. The magnetic flux density of the magnetic field can be adjusted to, e.g., 50 to 2000 G (gauss) (0.005 to 0.2 T (tesla)), and is preferably 200 to 1500 G (0.02 to 0.15 T), more preferably 500 to 1000 G (0.05 to 0.1 T).

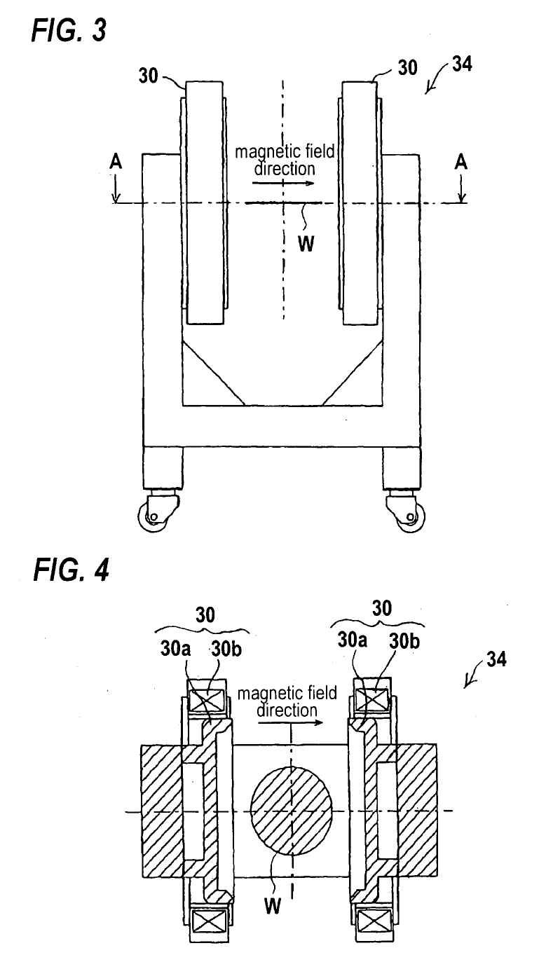

FIGS. 3 and 4 show an example of the magnetic field generation apparatus 34 that generates a magnetic field having a magnetic flux density of, e.g., 750 to 1500 G (0.075 to 0.15 T). The magnetic field generation apparatus 34 includes a pair of electromagnets 30, whose magnetic field direction is constant, disposed opposite to each other. Each electromagnet 30 is comprised of an iron core 30a and a coil 30b wound around the iron core 30a with the number of turns 500 to 1250 T. The resistance of the coil 30b is 3.5 to 10Ω (20° C.), so that by passing an electric current of DC 25A, the electromagnets 30 can generate a magnetic field having a magnetic flux density of 1000 G (0.1 T). The electromagnets 30 can be cooled (water-cooled) by passing cooling water at a flow rate of 3 to 10 L/min.

The magnetic field generation apparatus 36 can be used either for a substrate held in a horizontal position or for a substrate held in a vertical position.

In this embodiment, the electroless plating apparatus 36 is provided with an openable/closable lid 68 which has spray nozzles 66 for spraying a rinsing liquid, such as pure water, outwardly (upwardly) and can cover the top opening of the plating tank 40. With this structure, when the lid 68 is in a retreat position lateral to the plating tank 40, the substrate W held by the substrate holder 42 is brought into contact with the plating solution 38 in the plating tank 40 to carry out electroless plating. After the plating, the substrate holder 42 is raised and then the lid 68 is positioned at a position where it covers the top opening of the plating tank 40, and pure water or the like is sprayed toward the substrate W from the spray nozzles 66 of the lid 68 to rinse the surface (lower surface) of the substrate W.

Processing of a substrate by the substrate processing apparatus shown in FIG. 1 will now be described.

First, a dry substrate is taken by the first substrate transport robot 26 out of a substrate cassette mounted in the loading/unloading section 12, and the orientation of the substrate is confirmed or adjusted with a notch portion, an orientation flat, or the like of the substrate as a reference, using the aligner 16 in the main frame 10. For example, alignment of the substrate is made so that the direction of a magnetic field, applied to the surface of the substrate and parallel to the substrate, will be parallel or vertical to the notch portion or the like.

Next, the second substrate transport robot 28 receives the substrate from the aligner 16 and transports the substrate to the pretreatment apparatus 20. The pretreatment apparatus 20 reverses the substrate by 180 degrees so that the front surface (processing surface) faces downward. While rotating the substrate, e.g., at 20 rpm, a pretreatment solution (chemical solution) is sprayed from a plurality of spray nozzles toward the surface (lower surface) of the substrate, e.g., for 30 seconds to carry out first pretreatment (pre-cleaning) of the surface of the substrate. The pretreatment solution used in the first pretreatment (pre-cleaning) is, for example, an organic alkali-based cleaning solution. Thereafter, the substrate surface is rinsed, e.g., with pure water for 15 seconds.

Next, while rotating the substrate, e.g., at 20 rpm, a catalyst application solution (chemical solution) is sprayed from a plurality of spray nozzles toward the surface (lower surface) of the substrate, e.g., for 20 seconds to carry out second pretreatment (catalyst application treatment) of the surface of the substrate, thereby applying a catalyst, such as Pd, to the substrate surface. The catalyst application solution (chemical solution) used in the second pretreatment (catalyst application) is, for example, a solution of PdSO₄ in aqueous H₂SO₄. The concentration of PdSO₄ in the catalyst application solution is predetermined, e.g., in the range of 0.02 to 0.10 g/L and is, for example, 0.045 g/L. The concentration of H₂SO₄ in the catalyst application solution is predetermined, e.g., in the range of 20 to 100 g/L and is, for example, 60 g/L. Thereafter, the substrate surface is rinsed, e.g., with pure water for 15 seconds.

Though in this embodiment, the first pretreatment (pre-cleaning) and the second pretreatment (catalyst application) are carried out in the same pretreatment apparatus 20, it is also possible to carry out the first pretreatment and the second pretreatment in separate apparatuses as in the below-described embodiment. Further, depending on the type of a magnetic film (plated film) to be formed by plating, etc., it is possible to carry out only one of the first pretreatment (pre-cleaning) and the second pretreatment (catalyst application).

After the second pretreatment, the second substrate transport robot 28 receives the substrate from the pretreatment apparatus 20 and transports the substrate to the electroless plating apparatus 36 constituting the magnetic film forming apparatus 22. In the electroless plating apparatus 36, the plating solution 38 in the plating solution storage tank 50 has been heated, e.g., to 75° C. by the heating section 62, and the plating solution 38 has been circulated between the plating tank 40 and the plating solution storage tank 50 by driving the pump 52. The electroless plating apparatus 36 receives the substrate with the substrate holder 42, and lowers the substrate holder 42 to bring the surface (lower surface) of the substrate, held by the substrate holder 42, into contact with the plating solution 38 in the plating tank 40, thereby forming a plated film (magnetic film) selectively on a metal surface exposed on the substrate surface. In parallel with the above operation, after the substrate has reached a predetermined position in the plating solution 38, the stirring plate 44 disposed below the substrate is rotated to create a uniform flow of the plating solution 38 in the plating tank 40.

During the plating, electricity is applied to the pair of electromagnets 30 of the magnetic field generation apparatus 34 to generate, from outside the plating tank 40, a one-direction magnetic field parallel to and around the substrate, at least in the surface (lower surface) of the substrate. The magnetic flux density of the magnetic field formed in the substrate surface is, for example, 50 to 2000 G (gauss) (0.005 to 0.2 T (tesla)), preferably 200 to 1500 G (0.02 to 0.15 T), more preferably 500 to 1000 G (0.05 to 0.1 T). It is also possible to constantly apply electricity to the pair of electromagnets 30 of the magnetic field generation apparatus 34. Further, it is possible to change the strength of the magnetic field continuously or in a stepwise manner. The following is an example of the composition of plating solution that can be used to form a plated film (magnetic alloy film) of CoWP alloy by electroless plating.

### Composition of Plating Solution

CoSO₄.7H₂O: 14 g/L
Na₃C₆H₅O₇.2H₂O: 70 g/L
H₃BO₃: 25 g/L
Na₂WO₄.2H₂O: 12 g/L
NaH₂PO₂.H₂O: 21 g/L
pH: 9.1

After keeping the surface of the substrate in contact with the plating solution 38 in the plating tank 40 for a predetermined time, the substrate holder 42 is raised to withdraw the substrate from the plating solution 38 in the plating tank 40, and the lid 68 in the retreat position is positioned at the position where it covers the top opening of the plating tank 40. Thereafter, pure water is sprayed toward the surface of the substrate from the spray nozzles 66 disposed on the upper surface of the lid 68, e.g., for 5 seconds, thereby rinsing the substrate surface with pure water. The second substrate transport robot 28 receives the substrate, having the plated film (magnetic film) formed in the surface, from the substrate holder 42 of the electroless plating apparatus 36, and transports the substrate to the cleaning/drying apparatus 18.

In the cleaning/drying apparatus 18, the substrate is cleaned (rinsed) with a cleaning liquid, such as pure water, and then spin-dried by rotating the substrate at a high speed. The first substrate transport robot 26 receives the dried substrate from the cleaning/drying apparatus 18 and returns the substrate to the substrate cassette mounted in the loading/unloading section 12.

By thus using, as the magnetic film forming apparatus 22, the electroless plating apparatus 36 having the magnetic field generation apparatus 34 for generating a magnetic field around and parallel to a substrate, it becomes possible to form a magnetic film, especially a magnetic alloy film, having excellent coercive force characteristics with a uniform direction in a plane parallel to a substrate, selectively on a metal surface exposed on the surface of the substrate. Further, the composition and the magnetic properties of a plated film, e.g., composed of a magnetic alloy, can be easily controlled by adjusting the composition of a plating solution and the plating conditions. Furthermore, unlike an electroplating apparatus, there is no need to pass an electric current in a plating solution from an external power source. This facilitates the installation of the magnetic field generation apparatus 34 and, in addition, can provide a plated film (magnetic film) having a uniform thickness.

There is a case in which one magnetic film forming apparatus needs a processing time of ten and several minutes to several tens of minutes for a substrate for which the formation of a magnetic film having a thickness of several hundred to several thousand nm is necessary. Even in such a case, the provision of the four magnetic film forming apparatuses 22 in the main frame 10 in this embodiment can prevent the lowering of the throughput.

By holding a substrate W with its front surface facing downwardly by the substrate holder 42 as in this embodiment, the installation of the rotating shaft 48 for rotating the substrate W can be facilitated. By continually circulating the plating solution 38 using the overflow method, a decrease in the concentration of the plating solution 38 in the plating tank 40 can be prevented even when carrying out plating over such a long time as several minutes to several tens of minutes. Furthermore, by stirring the plating solution 38 in the plating tank 40 by the stirring plate 44, the flow of the plating solution 38 in the vicinity of the substrate W can be made uniform even when the substrate cannot be rotated, e.g., due to a structural restriction.

Though not shown diagrammatically in this embodiment, the magnetic film forming apparatus 22 may be provided with a monitoring apparatus for measuring the direction and strength of a magnetic field generated in a surface of a substrate in order to check if the magnetic field is properly formed.

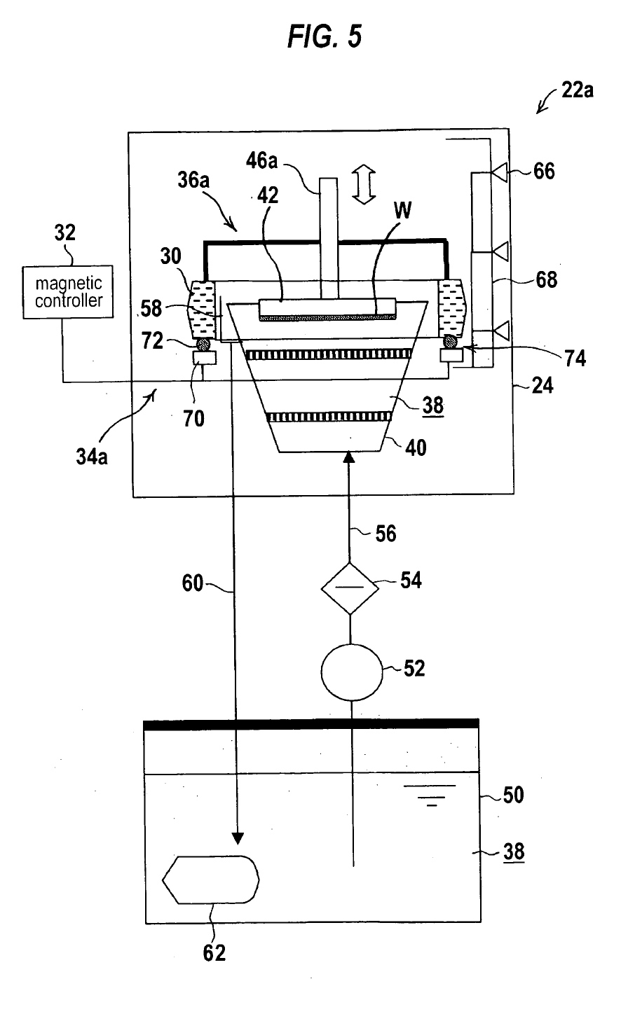

FIG. 5 shows another magnetic film forming apparatus. The magnetic film forming apparatus 22a shown in FIG. 5 differs from the magnetic film forming apparatus 22 shown in FIG. 2 in the following respects: The magnetic film forming apparatus 22a uses an electroless plating apparatus 36a in which the substrate holder 42 is coupled to the lower end of a rotatable and vertically-movable lifting shaft 46a and which does not employ a stirring plate. The apparatus 22a also uses a magnetic field generation apparatus 34a which makes the pair of electromagnets 30 rotatable by a slip ring 74 having a fixed brush 70 connected to the magnetic controller 32, and a rotator 72 on which the pair of electromagnets 30 is fixed. The other construction of the magnetic film forming apparatus 22a is the same as the magnetic film forming apparatus 22 shown in FIG. 2.

In operation of the magnetic film forming apparatus 22a, while rotating a substrate W, held by the substrate holder 42, e.g., at a speed of 1 to 100 rpm, for example 10 rpm, the substrate W is lowered to bring the surface of the substrate W into contact with the plating solution 38 in the plating tank 40. The rotation of the substrate is continued during plating. When supplying electricity to the pair of electromagnets 30 and thereby generating a magnetic field parallel to and around the substrate, at least along the surface (lower surface) of the substrate, the pair of electromagnets 30 is rotated, by the slip ring 74, in synchronization with the substrate W. e.g., at a speed of 1 to 100 rpm, for example 10 rpm, in the same direction as the rotational direction of the substrate, so that a constant positional relationship between the substrate W and the electromagnets 30 can be maintained during plating.

By thus rotating the substrate W, a uniform flow of the plating solution 38 can be formed in the plating tank 40 without using a stirring plate. Further, by maintaining a constant positional relationship between the substrate W and the electromagnets 30 during plating, a one-direction magnetic field can be generated around the substrate W.

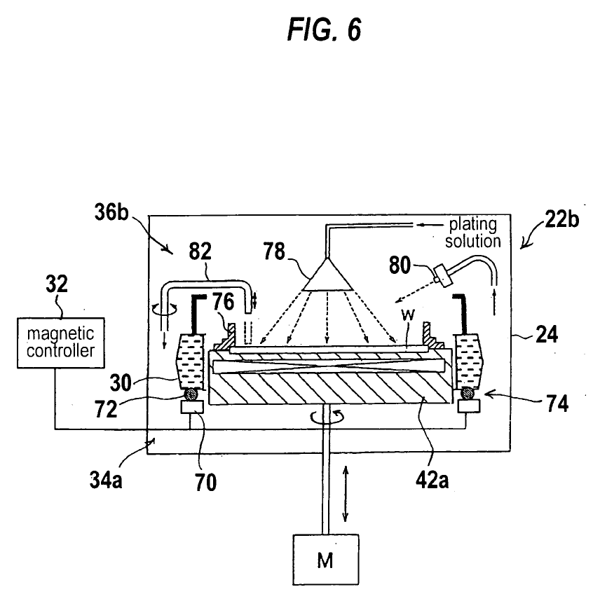

Though in the above-described embodiments, a plated film (magnetic film) is formed by electroless plating selectively on a metal surface exposed on a surface (lower surface) of a substrate W held with the surface facing downwardly, it is also possible to form a plated film (magnetic film) by electroless plating selectively on a metal surface exposed on a surface (upper surface) of a substrate W held with the surface facing upwardly, as shown in FIG. 6.

FIG. 6 shows a magnetic film forming apparatus 22b comprised of: an electroless plating apparatus 36b including a rotatable and vertically-movable substrate holder 42a for detachably holding a substrate W with its front surface facing upwardly, and a weir member 76 disposed above the substrate holder 42a; and the magnetic field generation apparatus 34a, shown in FIG. 5, which makes the pair of electromagnets 30 rotatable by the slip ring 74 having the fixed brush 70 connected to the magnetic controller 32, and the rotator 72 on which the pair of electromagnets 30 is fixed. In the electroless plating apparatus 36b, the substrate holder 42a holding a substrate W is raised to watertightly seal a peripheral portion of the substrate W with the weir member 76, thereby forming a plating tank, peripherally defined by the weir member 76, on the upper surface of the substrate W, and a shower of plating solution is supplied from a plating solution supply nozzle 78 into the plating tank when carrying out electroless plating.

A cleaning liquid is supplied from a cleaning liquid supply nozzle 80 to the plating tank on the upper surface of the substrate W, and the plating solution remaining on the upper surface of the substrate W is recovered through a plating solution recovery nozzle 82. A heater 84 for heating the plating solution in the plating tank is embedded in the substrate holder 42a.

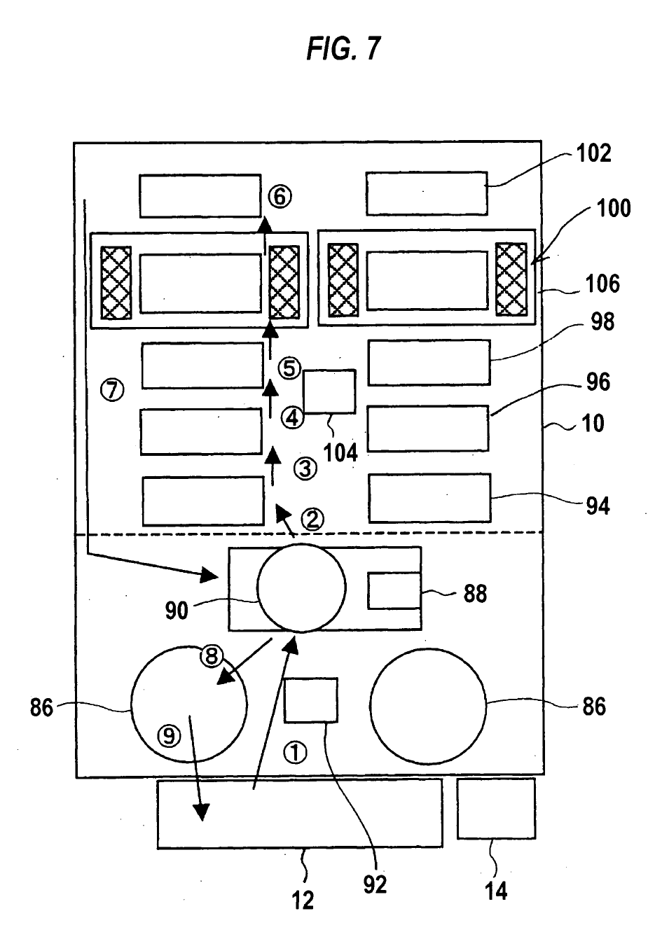

FIG. 7 shows a layout plan of a substrate processing apparatus according to another embodiment of the present invention. As shown in FIG. 7 and as with the substrate processing apparatus shown in FIG. 1, the substrate processing apparatus of this embodiment includes a rectangular main frame 10, a loading/unloading section 12 equipped with a substrate cassette housing therein substrates, such as semiconductor wafers, and a control section 14.

In the interior of the main frame 10 are disposed two cleaning/drying apparatuses 86 for cleaning (rinsing) the substrate with a cleaning liquid, such as pure water, and drying the substrate, and a substrate turning apparatus 90 for turning up or down the substrate by 90 degrees, provided with an aligner 88. Between these apparatuses is disposed a fixed-type first substrate transport robot 92. In the interior of the main frame 10 are also disposed two first pretreatment apparatuses 94 for carrying out a first pretreatment (pre-cleaning) of the substrate, two second pretreatment apparatuses 96 for carrying out a second pretreatment (catalyst application) of the substrate, two cleaning apparatuses 98 for cleaning (rinsing) the substrate, e.g., with pure water, two magnetic film forming apparatuses 100 for forming a magnetic film of, e.g., an alloy on a metal surface exposed on the surface of the substrate, and two post-cleaning apparatuses 102 for carrying out post-cleaning of the substrate. Between these apparatuses and the substrate turning apparatus 90 is movably disposed a second substrate transport robot 104.

As in the preceding embodiments, each magnetic film forming apparatus 100 is surrounded by a magnetic field shielding wall 106 that shields a magnetic field (magnetism), generated in the magnetic film forming apparatus 100, and prevents the magnetic field (magnetism) from causing as a noise a malfunction of an electrical component in the substrate processing apparatus.

The cleaning/drying apparatus 86 used in this embodiment holds a substrate with its front surface facing upwardly and carries out cleaning processing of the front surface (upper surface) of the substrate, whereas the first pretreatment apparatus 94, the second pretreatment apparatus 96, the cleaning apparatus 98, the magnetic film forming apparatus 100 and the post-cleaning apparatus 102 hold a substrate in a vertical position and carry out processing of the front surface (vertical surface) of the substrate. The substrate turning apparatus 90 turns a substrate, whose orientation has been confirmed or adjusted by the aligner 88, from a horizontal position to a vertical position (or vice versa) by 90 degrees.

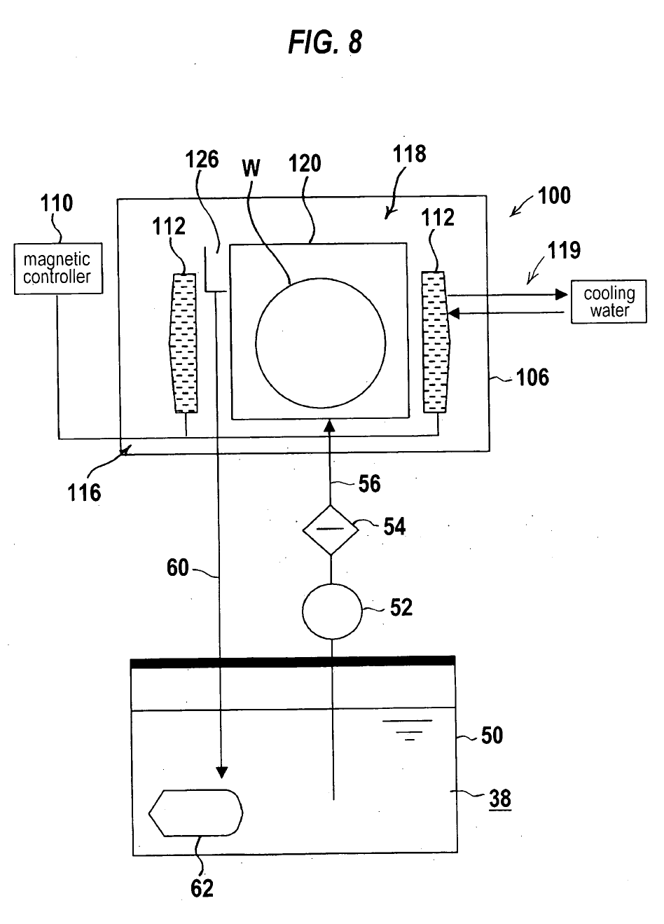

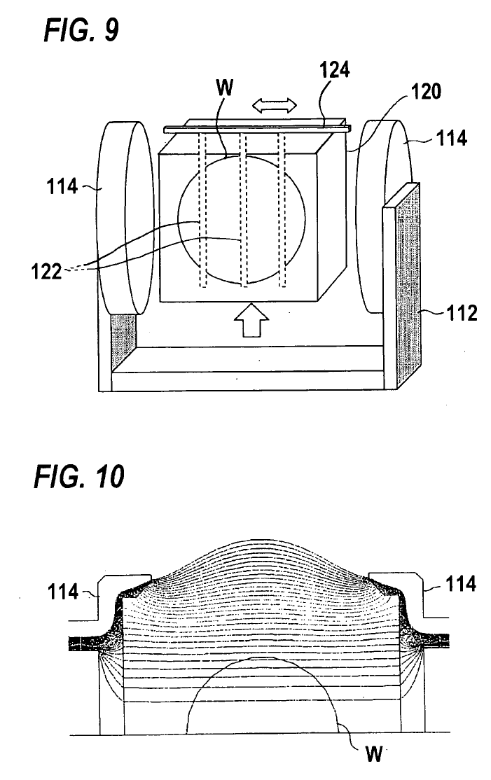

FIGS. 8 and 9 show the details of the magnetic film forming apparatus 100. As shown in FIGS. 8 and 9, the magnetic film forming apparatus 100 in this embodiment is comprised of an electroless plating apparatus 118 which includes a magnetic field generation apparatus 116 having a pair of electric coils 114 mounted on the side portions of a U-shaped yoke 112 (see FIG. 9) which is connected to a magnetic controller 110. The magnetic field generation apparatus 116 is provided with an electric coil cooling section 119 for cooling the electric coils 114 by supplying cooling water to the electric coils 114.

The electroless plating apparatus 118 also includes a rectangular box-like plating tank 120 for holding a plating solution 38 therein, and a vertically-movable substrate holder (not shown) for detachably holding a substrate W in a vertical position. In front of the substrate W held by the substrate holder are disposed vertically-extending stirring paddles 122, arranged parallel to each other, for stirring the plating solution 38 in the plating tank 120 during plating. The upper ends of the stirring paddles 122 are coupled to a drive shaft 124 which reciprocates parallel to the substrate W held by the substrate holder.

By stirring the plating solution 38 in the plating tank 120 by the stirring paddles 122, the flow of the plating solution 38 in the vicinity of the substrate W can be made uniform even when the substrate W cannot be rotated, e.g., due to a structural restriction as in this embodiment.

As with the above-described embodiment, the plating tank 120 at the bottom is connected to a plating solution supply pipe 56 extending from a plating solution storage tank 50 and having a pump 52 and a filter 54 interposed. Around an upper portion of the plating tank 120 is provided an overflow tank 126 for receiving the plating solution that has overflowed the top of the plating tank 120. The overflow tank 125 and the plating solution storage tank 50 are connected by a plating solution return pipe 60. In the plating solution storage tank 50 is disposed a heating section 62 for heating the plating solution 38 in the plating solution storage tank 50 to, e.g., 50 to 95° C., preferably 65 to 85° C.

The pair of electric coils 114 of the magnetic field generation apparatus 116 are disposed outside and on opposite sides of the plating tank 120 and orthogonally to the substrate W, as shown in FIG. 9, so that when bringing the surface (vertical surface) of the substrate W, held by the substrate holder, into contact with the plating solution 38 in the plating tank 120 and forming a plated film (magnetic film) by electroless plating selectively on a metal surface exposed on the substrate surface, a constant-direction, uniformly-distributed magnetic field parallel to the substrate W will be generated in the surface (vertical surface) of the substrate W, as shown in FIG. 10. The magnetic flux density of the magnetic field can be adjusted to, e.g., 50 to 2000 G (gauss) (0.005 to 0.2 T (tesla)), and is preferably 200 to 1500 G (0.02 to 0.15 T), more preferably 500 to 1000 G (0.05 to 0.1 T).

Processing of a substrate by the substrate processing apparatus shown in FIG. 7 will now be described.

First, a dry substrate is taken by the first substrate transport robot 92 out of a substrate cassette mounted in the loading/unloading section 12, and the orientation of the substrate is confirmed or adjusted with a notch portion, an orientation flat, or the like of the substrate as a reference, using the aligner 88 in the main frame 10. The substrate is then turned from a horizontal position to a vertical position by 90 degrees by the substrate turning apparatus 90.

Next, the second substrate transport robot 104 receives the substrate from the substrate turning apparatus 90 and transports the substrate to the first pretreatment apparatus 94. In the first pretreatment apparatus 94, the substrate in a vertical position is immersed in a pretreatment solution (chemical solution), e.g., for 30 seconds to carry out first pretreatment (pre-cleaning) of the surface of the substrate. As with the above-described embodiment, the pretreatment solution used in the first pretreatment (pre-cleaning) is, for example, an organic alkali-based cleaning solution.

Next, the second substrate transport robot 104 receives the substrate from the first pretreatment apparatus 94 and transports the substrate to the second pretreatment apparatus 96. In the second pretreatment apparatus 96, the substrate in a vertical position is immersed in a catalyst application solution (chemical solution), e.g., for 20 seconds to carry out second pretreatment (catalyst application treatment) of the surface of the substrate, thereby applying a catalyst, such as Pd, to the substrate surface. As with the above-described embodiment, the pretreatment solution used in the second pretreatment (catalyst application) is, for example, a solution of PdSO₄ in aqueous H₂SO₄.

Thereafter, the second substrate transport robot 104 receives the substrate from the second pretreatment apparatus 96 and transports the substrate to the cleaning apparatus 98. In the cleaning apparatus 98, the substrate in a vertical position is immersed in a cleaning liquid (rinsing liquid), such as pure water, e.g., for 20 seconds to clean (rinse) the surface of the substrate.

Thereafter, the second substrate transport robot 104 receives the substrate from the cleaning apparatus 98 and transfers the substrate to the substrate holder of the electroless plating apparatus 118 constituting the magnetic film forming apparatus 100. The substrate holder of the electroless plating apparatus 118 lowers the substrate in a vertical position to immerse it in the plating solution 38, heated, e.g., to 75° C. and circulating between the plating tank 120 and the plating solution storage tank 50, in the plating tank 120, thereby forming a plated film (magnetic film) selectively on a metal surface exposed on the surface of the substrate. During the plating, the stirring paddles 122 are reciprocated in front of the substrate to create a uniform flow of the plating solution 38 in the plating tank 120.

During the plating, electricity is applied to the pair of electric coils 114 of the magnetic field generation apparatus 116 to generate, from outside the plating tank 120, a one-direction magnetic field parallel to and around the substrate, at least in the surface (vertical surface) of the substrate. The magnetic flux density of the magnetic field formed in the substrate surface is 50 to 2000 G (gauss) (0.005 to 0.2 T (tesla)), preferably 200 to 1500 G (0.02 to 0.15 T), more preferably 500 to 1000G (0.05 to 0.1 T). It is also possible to constantly apply electricity to the pair of electric coils 114 of the magnetic field generation apparatus 116. Further, it is possible to change the strength of the magnetic field continuously or in a stepwise manner. The above-described composition of plating solution, for example, can be used to form a plated film (magnetic alloy film) of CoWP alloy by electroless plating.

After keeping the surface of the substrate in contact with the plating solution 38 in the plating tank 120 for a predetermined time, the substrate holder is raised to withdraw the substrate from the plating solution 38 in the plating tank 120. The second substrate transport robot 104 receives the substrate after plating from the substrate holder of the electroless plating apparatus 118 and transfers the substrate to the post-cleaning apparatus 102. The post-cleaning apparatus 102 carries out post-cleaning, such as scrub cleaning, of the surface of the substrate held in a vertical position while supplying a cleaning liquid to the substrate surface and, if necessary, rinses the substrate surface, e.g., with pure water.

The second substrate transport robot 104 receives the substrate after post-cleaning from the post-cleaning apparatus 102 and transports the substrate to the substrate turning apparatus 90, where the substrate in a vertical position is turned 90 degrees into a horizontal position with the front surface facing upwardly. The first substrate transport robot 92 then receives the substrate from the substrate turning apparatus 90 and transfers the substrate to the cleaning/drying apparatus 86, where the substrate is cleaned (rinsed) with a cleaning liquid, such as pure water, and then spin-dried by rotating the substrate at a high speed. The first substrate transport robot 92 receives the dried substrate from the cleaning/drying apparatus 86 and returns the substrate to the substrate cassette mounted in the loading/unloading section 12.

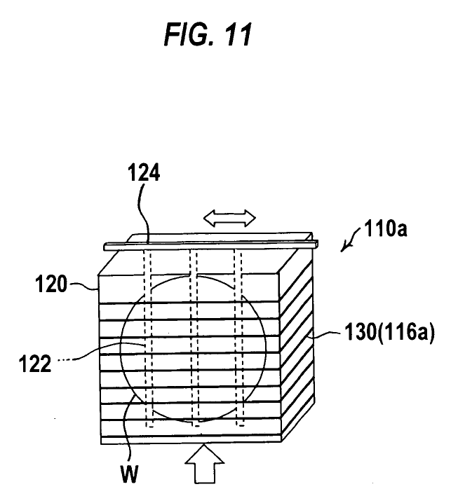

FIG. 11 shows the main portion of another magnetic film forming apparatus. The magnetic film forming apparatus 100a differs from the magnetic film forming apparatus 100 shown in FIGS. 8 and 9 in that the magnetic field generation apparatus 116a of the magnetic film forming apparatus 100a is comprised of an electric coil 130 wound around the plating tank 120 in a certain direction. The other construction of the magnetic film forming apparatus 10a is the same as the magnetic film forming apparatus 100 shown in FIGS. 8 and 9.

The previous description of embodiments is provided to enable a person skilled in the art to make and use the present invention. Moreover, various modifications to these embodiments will be readily apparent to those skilled in the art, and the generic principles and specific examples defined herein may be applied to other embodiments. Therefore, the present invention is not intended to be limited to the embodiments described herein but is to be accorded the widest scope as defined by limitation of the claims and equivalents.

What is claimed is:

1. An apparatus for forming a magnetic film selectively on a metal surface exposed on a surface of a substrate, the apparatus comprising an electroless plating apparatus having a magnetic field generation apparatus for generating a magnetic field around and parallel to a substrate disposed such that the surface of the substrate is in contact with a plating solution in a plating tank.

2. The magnetic film forming apparatus according to claim 1, wherein the plating tank holds the plating solution while allowing the plating solution to overflow the peripheral wall of the plating tank and circulate.

3. The magnetic film forming apparatus according to claim 1, wherein the plating tank has a stirring device for stirring the plating solution held in the plating tank.

4. The magnetic film forming apparatus according to claim 1, wherein the magnetic field generation apparatus generates a magnetic field either by using a permanent magnet or by using an electric coil.

5. The magnetic film forming apparatus according to claim 1, further comprising a magnetic field shielding wall surrounding the magnetic field generation apparatus for shielding a magnetic field.

6. An apparatus for forming a magnetic film selectively on a metal surface exposed on a surface of a substrate, the apparatus comprising an electroless plating apparatus including:
a plating tank for holding a plating solution therein;
a substrate holder for holding a substrate and bringing a surface of the substrate into contact with the plating solution in the plating tank; and
a magnetic field generation apparatus, disposed outside the plating tank, for generating a magnetic field around and parallel to the substrate disposed such that the surface of the substrate is in contact with the plating solution in the plating tank.

7. The magnetic film forming apparatus according to claim 6, wherein the plating tank holds the plating solution while allowing the plating solution to overflow the peripheral wall of the plating tank and circulate.

8. The magnetic film forming apparatus according to claim 6, wherein the plating tank has a stirring device for stirring the plating solution held in the plating tank.

9. The magnetic film forming apparatus according to claim 6, wherein the substrate holder holds the substrate in a horizontal position with the surface facing either upwardly or downwardly.

10. The magnetic film forming apparatus according to claim 6, wherein the substrate holder holds the substrate in a vertical position.

11. The magnetic film forming apparatus according to claim 6, wherein the substrate holder is rotatable, and the magnetic field generation apparatus is adapted to rotate in synchronization with the substrate, held and being rotated by the substrate holder, in the same direction as the rotational direction of the substrate.

12. The magnetic film forming apparatus according to claim 6, wherein the magnetic field generation apparatus generates a magnetic field either by using a permanent magnet or by using an electric coil.

13. The magnetic film forming apparatus according to claim 6, further comprising a magnetic field shielding wall surrounding the magnetic field generation apparatus for shielding a magnetic field.

14. A method for forming a magnetic film, comprising applying a magnetic field around and parallel to a substrate while keeping a surface of the substrate in contact with a plating solution to carry out electroless plating of the surface of the substrate, thereby forming a magnetic film selectively on a metal surface exposed on the surface of the substrate.

15. The magnetic film forming method according to claim 14, wherein the substrate is held in a horizontal position with the surface facing either upwardly or downwardly.

16. The magnetic film forming method according to claim 14, wherein the substrate is held in a vertical position.

17. The magnetic film forming method according to claim 14, wherein the substrate in contact with the plating solution is rotated in one direction and the magnetic field is simultaneously rotated in synchronization with the substrate in the same direction as the rotational direction of the substrate.

18. The magnetic film forming method according to claim 14, wherein the strength of the magnetic field is changed continuously or in a stepwise manner.

19. The magnetic film forming method according to claim 14, wherein the magnetic field is uniformly distributed over the surface of the substrate at a magnetic flux density of 50 to 2000 gauss.

20. A substrate processing apparatus comprising:
the magnetic film forming apparatus according to claim 1;
an aligner for alignment of the orientation of a substrate; and
a main frame housing the magnetic film forming apparatus and the aligner therein.

21. The substrate processing apparatus according to claim 20, wherein at least four magnetic film forming apparatuses are provided in the main frame.

22. A substrate processing apparatus comprising:
the magnetic film forming apparatus according to claim 6;
an aligner for alignment of the orientation of a substrate; and
a main frame housing the magnetic film forming apparatus and the aligner therein.

23. The substrate processing apparatus according to claim 22, wherein at least four magnetic film forming apparatuses are provided in the main frame.
